(19) United States
(12) Patent Application Publication
(10) Pub. No.: US 2008/0001578 A1
(43) Pub. Date: Jan. 3, 2008

(54) Motion Activated Power Source

(75) Inventor: George Jaroslav Cap, Robertson (AU)

Correspondence Address: CONNOLLY BOVE LODGE & HUTZ LLP, 1875 EYE STREET, N.W., SUITE 1100, WASHINGTON, DC, 20036, US

(73) Assignee: Kinergi Pty Ltd, Schney (AU)

(21) Appl. No.: 11/572,609

(22) PCT Filed: Jul. 27, 2005
(86) PCT No.: PCT/AU05/01093

§ 371 Date: Jan. 24, 2007

(30) Foreign Application Priority Data
Jul. 28, 2004 (AU) 2004904182

(51) Int. Cl. H02K 35/04; H02N 2/18

(52) U.S. Cl. 322/3; 310/17; 310/25

(57) ABSTRACT

An electrical generator which includes a magnetic field generated within a housing (10) by permanent magnets (19, 20) located within the housing and a coil (23) is resiliently mounted within the magnetic field such that movement of the housing induces movement of the coil to generate a current. The generator includes an electronics device (45) connected to the coil which is adapted to rectify the current and incorporating a charge storage device (46). In one embodiment, at least one coil is suspended on a torsion wire (33) within the magnetic field and the torsion wire carries a counter weight (47) whose mass is selected to resonate with the vibrational frequency to which the generator is subjected. The coils are arranged to oscillate at frequencies less than 100 Hz and are particularly useful in harvesting the motion and vibration of vehicles.

This invention relates to a magnetic based electric power source as a substitute for batteries and mains power connections, that draw on ambient vibrations or motion.

### BACKGROUND TO THE INVENTION

For some time there has been interest in harvesting energy from vibrations or motion such as walking to provide power as a replacement for batteries. Two sources of electric power have been used previously piezoelectric devices and magnetic devices.

U.S. Pat. No. 3,480,808 discloses a generator in which a coil moves relative to a magnet or a magnet moves relative to a coil.

U.S. Pat. Nos. 4,412,355 and 4,471,353 disclose a switch that powers a transmitter to switch on a remote light using the current generated by a magnet on a vibrating reed interacting with a coil.

U.S. Pat. No. 5,347,186 discloses in part a battery replacement device using magnetically levitated magnets oscillating within coils. As a battery replacement, the electronics includes rectifiers and a capacitor.

U.S. Pat. No. 5,818,132 generates electric power from the linear movement of a magnet through a coil

U.S. Pat. No. 5,838,138 uses a sprung magnet on a key of a key board moving in a coil to generate electric power to recharge batteries on a portable computer or similar device.

U.S. Pat. No. 5,945,749 discloses a power generator for devices on a train which uses the motion of the train to oscillate a magnetic piston within a coil.

U.S. Pat. No. 6,220,719 provides a torch with a magnet able to reciprocate within the torch barrel which is wound with coils. The arrangement includes a capacitor for storing charge.

U.S. Pat. No. 6,291,901 discloses an automobile wheel with a magnet and coil arranged so that deflection of the tire causes relative motion between the magnet and the coil to generate electricity.

These prior art devices are limited to harvesting energy from dynamic motion or vibration energy inputs which require a higher threshold typically frequencies above 10,000 hz than is available from many environmental motion and vibration sources.

PCT/AU03/01523 discloses a generator in which a coil mounted at the remote end of an L shaped membrane is moved by environmental vibrations to oscillate within a magnetic field.

There is a need for a device which can passively harvest energy from low level motion and vibration sources and which can replace conventional batteries.

### BRIEF DESCRIPTION OF THE INVENTION

To this end the present invention provides an electrical generator as a portable battery replacement which includes
a) A housing
b) A magnetic field generated within said housing by permanent magnets located within the housing
c) At least one coil resiliently mounted within the magnetic field such that movement or vibration of the housing induces movement of the coil in the magnetic field to generate an electric current in the coil
d) An electronics device electrically connected to said coil adapted to rectify the current produced and incorporating a charge storage device.

An advantage of this invention resides in the fact that it is the coil that moves rather than a magnet. The coil provides the main inertial mass of the generator and because its weight can be conveniently lighter than the magnets the generator is sensitive to lower energy vibrations particularly those below 100 Hz, which are more abundant in vehicles or from movements such as walking. The resilient suspension may be provided by magnetic levitation but is preferably provided by coil springs within the housing and providing the electrical connection to the coil.

The coil may be fitted with a small mass to increase its momentum and sensitivity to lower energy vibrations, and to overcome the inductive resistance threshold of the permanent magnets. The resonant mass of the coil can be adjusted to create mechanical resonance at a particular harvesting frequency.

Incorporation of the Offset Weight has Two Functions

(1) To increase the coil momentum and sensitivity to lower energy vibrations, and to overcome the inductive resistance threshold of the permanent magnets.
(2) To adjust the mechanical resonance of the coil-mass combination and the spring mechanism of the device so that it can be matched to the particular harvesting frequency of the application.

The first embodiment of the invention has a cylindrical coil suspended by coil springs, which allow the coils movement through a radial magnetic field generated by permanent magnets.

In a second embodiment of the invention there are three coils resiliently mounted on a torsion wire suspended between said permanent magnets with a counter weight also mounted on the torsion wire, but suspended outside the permanent magnets. Mechanical resonance is achieved by adjusting the mass of the counter weight.

The magnetic field is provided by a permanent magnet or an array of permanent magnets. Preferably the magnetic flux is non linear and the permanent magnets are configured to maximize the magnetic flux over the path of the moving coil to maximize current generation.

A third embodiment of the invention there are eight coils resiliently mounted within a disk shaped caddy. The torsion wire runs through the vertical axis of the caddy. The permanent magnets are distributed radially on top and bottom of the caddy.

The generator of this invention harvests the mechanical energy of motion and converts that mechanical energy into storable electrical energy. The device has a passive parasitic operation meaning that it converts energy without any active input, i.e. there are no buttons to push nor is there any required intentional shaking or direct activation of any kind. The device is parasitically attached to or placed into a receptacle that is attached to a moving object.

As the coils pass through the field created by permanent magnets arranged around the coils they generate an AC voltage, which appears at the coil output wires. The voltage generated can be used to charge a capacitor or a battery. The invention may be used as a movement energy sensor. By attaching the invention to a moving object it can give an indication of movement intensity. This is because the AC voltage generated by the invention is proportional to how vigorously the object moves. To maximize the harvesting potential of the invention, the magnetic field strength within the cavities is maximized. This is achieved by reducing the width of the magnetic cavity and the placement of smaller magnets in specific alignments within the cavity, increasing the flux density through which the coil must pass. The smaller magnets act as ‘boosters’ to the diminishing field passing through the coil.

A second embodiment has the one coil separated into 3 or 4 coils connected in series. This is specific to the magnetic circuit design and maximizes the harvesting efficiency of the invention.

It is well established that one of the parameters defining the generation of Voltage by induction from a coil is the number of turns.

The field versus distance from a pole face of a magnet is proportional to the inverse square of the distance. This invention is in part based the consequences of applying this principle to a coil passing through a field generated by two permanent magnets. The thicker the coil the further the magnets must be placed apart, and consequently the weaker (proportional to the inverse square of the separation) field in between. This invention is in part predicated the realisation that magnetic separation is a crucial point of the design of magnetic circuits. The design of this embodiment maximizes the slot width, slot number, placement and pattern in a magnet, whilst at the same time maximizing the magnetic field strength within the slots. The coil is split into several coils connected in series, specifically to fit into the number of slots in the magnet. As all of the coils are resiliently fixed to move as one, physically connected by the torsion bar, they will respond to external excitement in unison, acting as one coil with the same number of turns. Increasing the flux density in the oscillation path of the coils, increases the combined three-coil output voltage for a given inertial input. This procedure maximizes the harvesting potential of the invention.

The magnets used may be any suitable permanent magnets able to generate the appropriate magnetic field strengths. Magnets formed using magnetic nanoparticles as disclosed in specification PCT/AU2004/00728 may be used. Magnetic particles as disclosed in that patent can be incorporated in a polymeric matrix to provide a light weight permanent magnet. Reduction of weight in the generator makes the generator useful in powering devices where weight is a design issue.

The electronic module is required to
(a) Rectify and voltage quadruple the input waveform
(b) Store the rectified DC energy as charge in a storage device (capacitor, super capacitor or rechargeable battery)
(c) Sense if the amount of charge stored is enough to drive the particular application and if so enabling the conduction of that charge. The amount of charge is sensed by a voltage detector, which enables the charge to conduct to the next stage only when the voltage on the specifically sized storage capacitor reaches a predetermined value.
(d) Output the voltage through a DC-DC switch mode voltage converter, specifically chosen to output the voltage required by the application.

The electronics can be modified to suit the requirements of any application, and if the power is not available will run in duty cycle mode (i.e. it will cycle through a turn on only when it has enough power to run the application and off when recharging)

The device is tuned by assessing the major frequencies of vibration available in the application, and the displacement distance of that vibration. The mechanical resonance (i.e. the coil mass-spring resonance) of the device is designed to resonate at the frequency. The displacement distance is related to the energy in each oscillation and is used to evaluate the spring constant (or ‘spring-ey-ness’) of the springs. The thicker the cross section of the springs the more spring resistance the spring has and the more powerful the recoil.

To make use of the AC voltage as a generator, the voltage needs to be converted to a DC current by a rectification circuit and then stored in a capacitor. In many applications, the voltage generated is not high. Preferably schottky diodes with low voltage turn on specifications are used in the quadrupler/rectification circuit,

The devices embodying this invention can be small, lightweight, and unobtrusive and yet generate sufficient electric energy to power sensor or alarm circuits and transmitters in applications where battery power is usually needed. This includes most remote sensing where motion or vibration is experienced as in land, air and water vehicles, buoys, vehicle and animal tracking devices, pagers etc.

The device of this invention is particularly applicable to energizing transponders used in tracking vehicles or containers or collecting tolls from vehicles. The power requirement for transponders is from 1 to 2 mW during transmission and about 55 milliamps, this is equivalent to a supply voltage of 3 Volts enabled for 100 mSec. The size and weight of the device needs to be similar to that of an AA battery. This power requirement can be harvested from vibrations in the 2-20 Hz range which is achievable in motor vehicles and trucks. The third embodiment of the device with a size of about ⅔ of a packet of 20 cigarettes is larger than the second embodiment and can generate with an appropriate inertial input about 100 mWatt of power.

### DETAILED DESCRIPTION OF THE INVENTION

A preferred embodiment of the invention will be described with reference to the drawings in which:

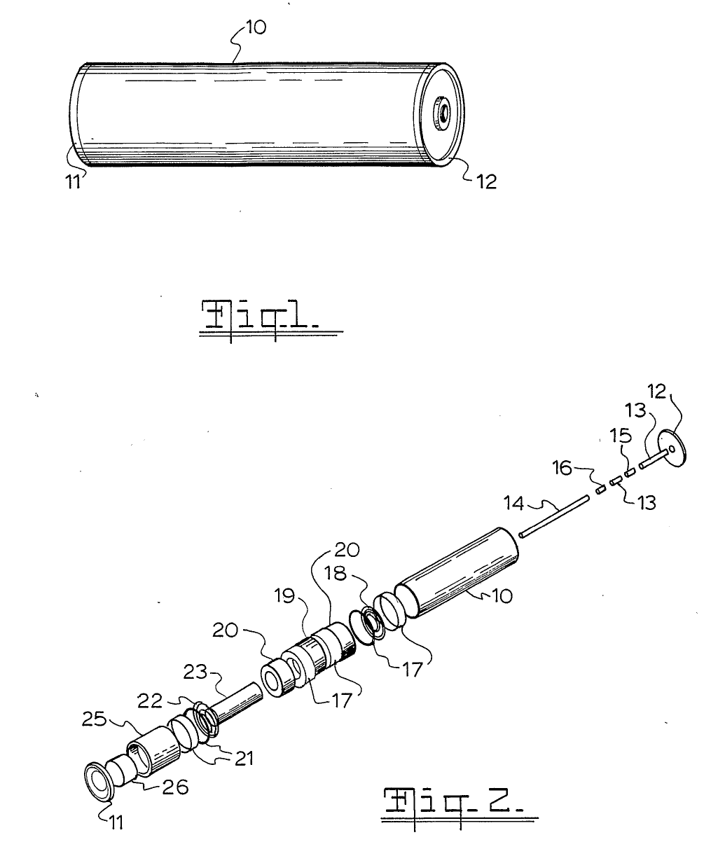

FIG. 1 is an unexploded assembly drawing of the proposed prototype of the invention;

FIG. 2 is an exploded drawing of the above prototype with the components labelled;

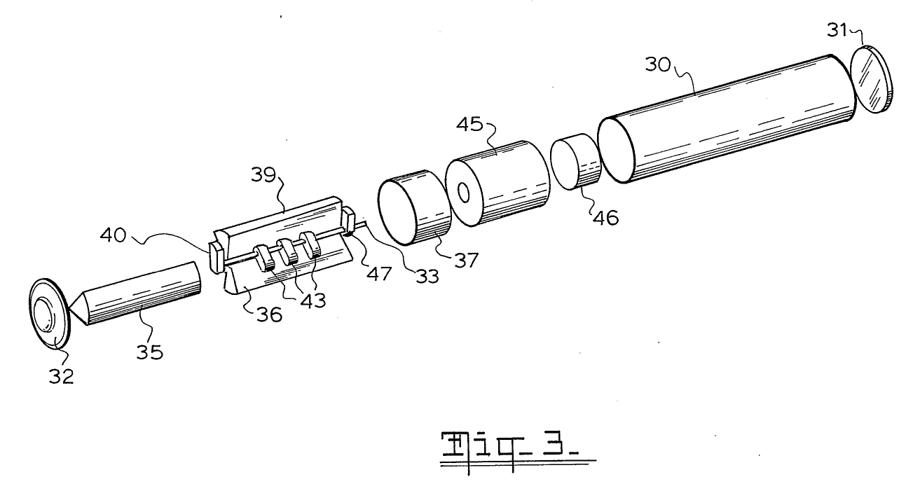

FIG. 3 is the exploded drawing of the second embodiment of the device.

FIG. 4 is a schematic drawing of the electronic circuit used in the device;

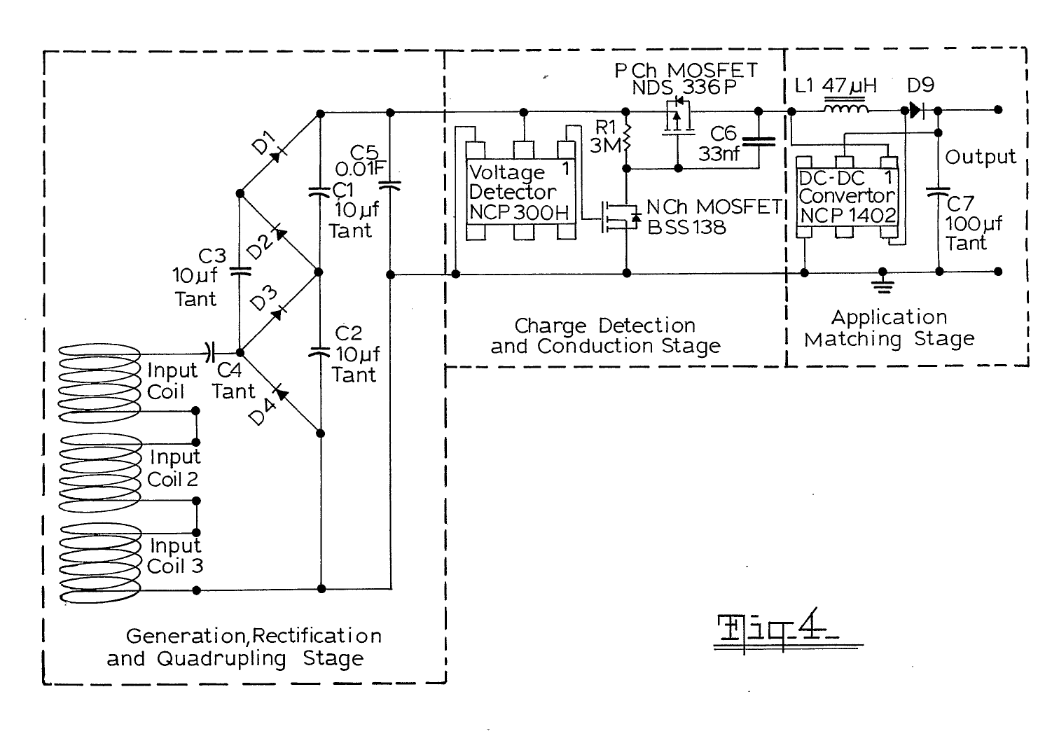

FIG. 5 is an exploded view of a third embodiment of the invention;

FIG. 6 is a cross section of the embodiment shown in FIG. 5;

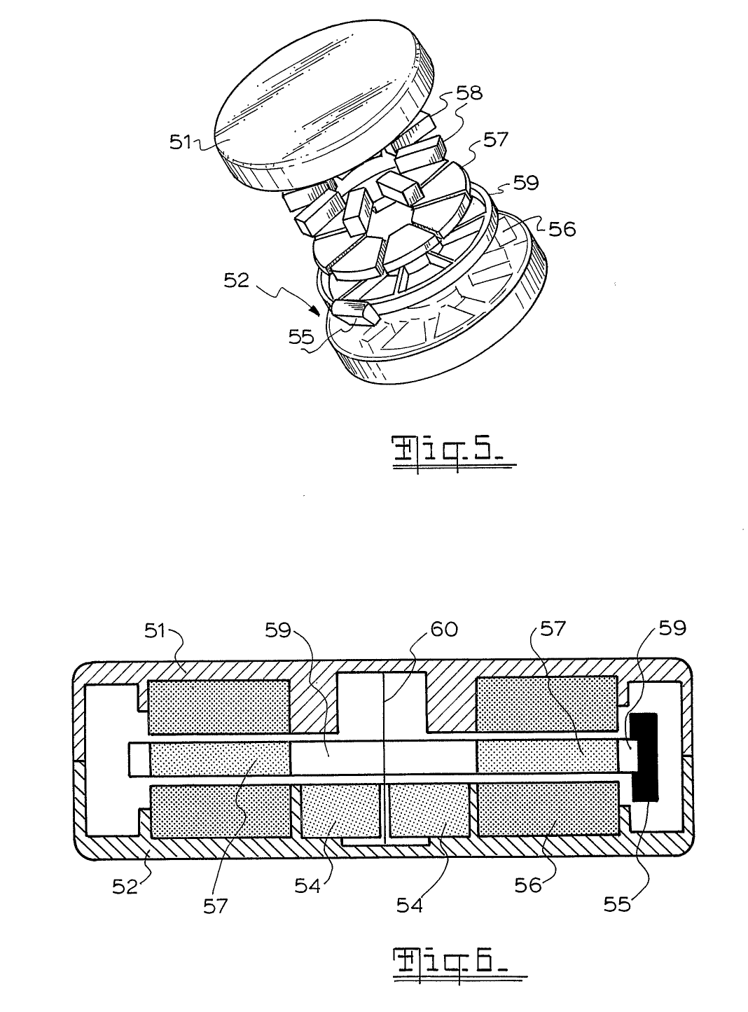

FIG. 7 illustrates the magnetic polarity set up of the embodiment of FIG. 5;

FIG. 8 illustrates the coil series connection sequence of the embodiment of FIG. 5.

The embodiment of FIG. 2 uses a single electrical coil 23 suspended by 2 coil springs 18,22 within a pair of toroidal magnets 19,20. Electrical connection between the electrical coil and the electronics is via the coil springs 18,22. The magnets are held within the casing 10 and the end cap 11 and top cap 12. Spacers 17,21 hold the magnets in position within the casing 10. A central shaft is formed by mild steel spacers 13 and bottom axis magnet 15 and top axis magnet 16. The electronics pack 25 and the super capacitor 26 are located adjacent the end cap 11. The toroidal magnets are polarised in two directions focussing the north magnetic pole inwards in magnets 20 and focussing the north magnetic pole outwards in magnets 19. Two smaller magnets 15 and 16 placed with fields opposing, are separated by mild steel rods 13 this arrangement fits into non-magnetic sleeve 14. The smaller magnets act to draw the diminishing magnetic field of the toroidal magnets into the centre of the invention thereby increasing the magnetic field strength through which the coil will pass. Spacers 17,21 keep the vital parts in position, within the outer casing 10 and the top cap 12 and bottom cap 11. The invention functions by the inertial capture of mechanical energy moving the coil with respect to the magnetic fields of the permanent magnets, thereby generating energy.

In the FIG. 3 embodiment three electrical coils 43 are resiliently mounted on a torsion wire 33 suspended between four permanent magnets 35, 36, 39 and 40, with a counter weight 47 mounted on the torsion wire 33, but suspended outside the permanent magnets 35,36,39,40. Electrical connection between the coils 43 and the electronics may be via the torsion wire 33. The harvested energy is stored in the storage device 46 preferably a super capacitor. Electrical connection between the coils 43 and the electronics 45 may be via the torsion wire 33. Spacer 37 keeps the vital parts in position, with the outer casing 30, the top cap 32 and end cap 31. The invention functions by the inertial capture of mechanical energy moving the masses (or single mass) connected to the coils with respect to the magnetic fields within the slots of the permanent magnets, thereby generating energy. The advantage of the torsion system is that it allows energy capture from two degrees of freedom, compared with one degree in the first embodiment.

In the battery replacement model as proposed in the embodiments of FIGS. 2 and 3 field strengths of 0.4 to 0.6 Tesla have been achieved between the slots in the magnets.

The electronics pack will normally include a Voltage Detector Module and a DC to DC switch mode voltage converter Module.

Voltage Detector Module

When batteries are connected to a circuit, voltage instantly appears in the circuit and the circuit begins to function as expected. For energy harvesters the voltage appears in the circuit as it is generated. Because of the large capacity of the super-capacitor (0.01 Farad) it may take some time to charge the device to useable voltage levels, even though the actual energy stored in the capacitor may be enough to drive the particular application. Although super-capacitors are chosen to suit the application, the charge time may cause problems when turning on some microcomputers and integrated circuits. This occurs when the charging rate of the super-capacitor is not high enough, initiating a ‘partial turn on state’, where the micro or integrated circuit tries to pull up to its operating voltage by draining more and more current. Unfortunately if this process is allowed to continue, all the charge from the storage capacitor will be exhausted without turning on the application.

This problem is overcome using a voltage detector, and a MOSFET turn off mechanism, which places upper and lower limits (respectively) on the conduction of charge from the super-capacitor. The detector is set so that it senses when the output voltage of the super-capacitor is at a predetermined voltage. When the charge in the super-capacitor reaches the predetermined value the voltage detector turns on a N channel MOSFET enabling conduction to the application matching stage through the P channel MOSFET (see FIG. 4).

This means that when the device is charged and ready to function it automatically turns itself on to drive the application and vice versa. The charge detection and conduction stage behaves as an automatic on/off switch. So that if there is enough vibration to keep the harvested energy requirements above the demands of the application then the harvester will behave as if it were a battery. If the harvested energy is not enough for the demands of the application, the charge detection and conduction stage will automatically move into a duty cycle mode. This means that it will conduct charge at the required voltage until the charge on the super-capacitor is depleted, turn off, and it will wait until it has enough charge to perform another cycle.

The turning off function is controlled by the draining of charge off the gate of the P channel MOSFET achieved by the resistor Capacitor combination R1-C6 (see FIG. 4).

DC to DC Switch Mode Voltage Converter Module

A switch mode step-up DC to DC voltage converter is used to convert the voltage to a useable level as required by the application. The supply current will decrease in proportion to the voltage increase, and there are losses in the efficiency (80%) and drive current (30 uA) of the converter.

Typically the converter will start-up when the voltage in the capacitor as seen by the switch-mode during conduction rises above 0.8 Volts. Once turned on the device will continue to operate until the voltage in drops below 0.3 Volts. DC to DC voltage converters are available to convert to output voltages between 3 and 5 volts in 0.5 volt steps.

This means that by replacing the switch-mode converter with one suitable to the application, the harvesting device has the drive capability to suit any application between 3-5 volts, in either direct or duty cycle mode depending on the vibrational energy available.

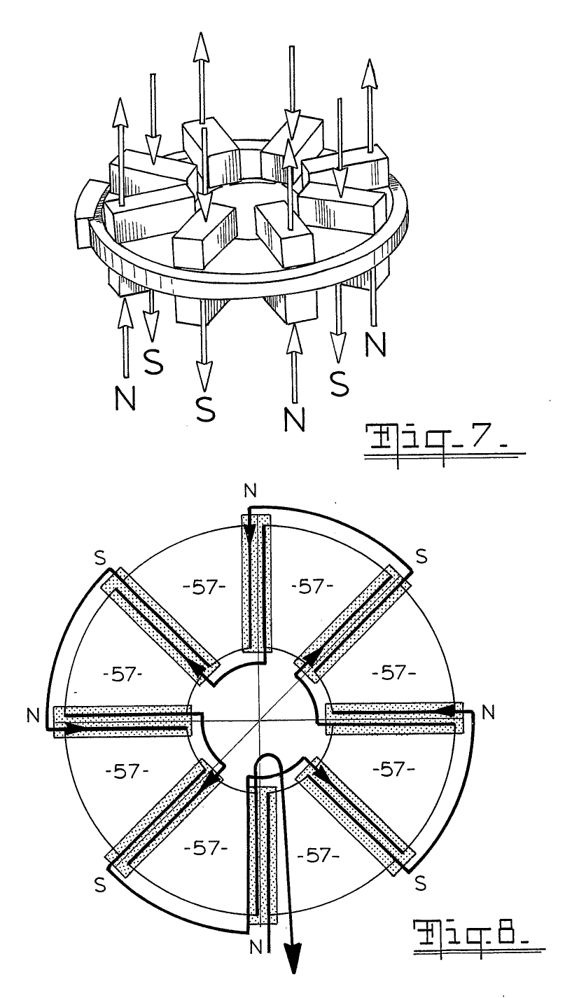

The embodiment illustrated in FIGS. 6 to 10 is a variation of the FIG. 4 embodiment in that a torsion wire is used as the spring but the coils and magnets are arrayed in a wide cylindrical body formed by the top cover 51 and bottom cover 52. The coils 57 are carried on a caddy 59 supported by the torsion wire 60. The caddy 59 carries the offset weight 55. The electronics 54 are placed at the centre of the bottom cover 52.

The caddy oscillates with the coils between the array of magnets 56 and 58. The coils 57 set into the caddy 59, are moved through the magnetic fields of the permanent magnets 56,58, thereby generating energy. The polarity of the magnet array is shown in FIG. 7. The 8 coils are connected in series as shown in FIG. 8. Each coil is 300 turns of 125 micron wire each with a resistance of 25 ohms making 200 ohms as the total resistance. The coils are all wired in series but to facilitate the optimum generation of energy and magnet polarity have a specific order (see FIG. 8). The odd number coils are connected in series before the even numbers, ie the coil connection order is: 1, 3, 5, 7, 2, 4, 6 and 8. Also the winding directions of the odd numbers are clockwise whilst the even are anticlockwise. Top and bottom mild steel disks may be placed on this embodiment. The disks being ferromagnetic act as magnetic field conduits enhancing the conduction of the magnetic fields. This has a dual effect;
(1) By enhancing the flow of magnetic flux greater field strengths are possible between the magnets;
(2) The better conduction of magnetic flux through the disks reduces the strength of the magnetic field penetration exterior to the invention.

In all embodiments the spring be it a torsion wire or coil, provides the mechanism that restores the coils to their original position.

In the embodiment of FIG. 5, field strengths of 0.4 Tesla have been achieved between the magnets, without the top and bottom plates in place. Field strengths of 0.6 Tesla have been achieved with the disks in place.

The offset weight 55 parasitically captures two-dimensional tangential momentum converting it to angular momentum which also moves the caddy 59 in the same direction. This movement places a shear stress on the torsion wire 60 which acts as a spring resisting the angular motion of the caddy 59. This resistance increases up to the point where the angular torsion (stored in the shear stress of the wire) exactly balances the angular momentum of the caddy and the motion stops. At this point the shear stress in the spring gradually accelerates the caddy 59 in the opposite direction until it reaches a maximum angular velocity after which it begins to decelerate due to the shear stress build up in the torsion wire 60. Unless it is interrupted this motion is periodic and the oscillations will decay in each cycle until the caddy comes to rest. The constant motion or vibration maintains the oscillations. As the coils oscillate within the strong magnetic fields produced by the magnets 56,58 current is produced in the coils creating power.

This invention is particularly useful in
1 standard battery type packages (e.g.: ‘D’ cell or ‘Lantern’)
2. Novelty toys for children or executive toys
3. Powering Shipping Container and Cargo identification devices
4. Active tagging
5. powering all types of tracking and monitoring devices
6. Athlete (or player) sensor and location monitoring
7. Competition equipment sensor and location monitoring (e.g.: sculls, javelins etc)

From the above those skilled in the art will realise that this invention differs from previous attempts in
Using moving coils and not moving magnets allowing for better shielding of the magnetic field lines.
Using moving coils and not moving magnets allowing for greater flexibility to create resonance with and sensitivity of lower energy vibrations
Using a unique configuration of magnet geometry to optimise the magnetic flux in the path of the vibrating coils.
Maximising the size of the fixed magnets to create the strongest magnetic fields possible for the size limitations of the device.
Having a passive operation meaning that it converts energy without any active input, ie there are no buttons to push nor is there any required shaking or direct activation of any kind. The device is used in place of a conventional storage battery

Those skilled in the art will realise that the present invention may be adapted for use in a range of applications and sizes and can be shaped to fit the requirements of the desired application.

1. An electrical generator as a portable battery replacement which includes
a) a housing
b) a magnetic field generated within said housing by permanent magnets
c) at least one coil resiliently mounted within the magnetic field such that movement or vibration of the housing induces reciprocal movement of the coil in the magnetic field to generate an electric current in the coil
d) an electronics device electrically connected to said coil adapted to rectify the current produced and incorporating a charge storage device.

2. An electrical generator as claimed in claim 1 in which the magnetic field is provided by permanent magnets which are configured to maximize the magnetic flux in the path of the moving coil by optimizing the size and shape of the coil relative to the gap between the magnets.

3. An electrical generator as claimed in claim 1 in which the at least one coil is suspended on a torsion wire within the magnetic field and the torsion wire carries a counter weight whose mass is selected to resonate with the vibrational frequency to which the generator is subjected.

4. An electrical generator as claimed in claim 1 in which the coils are arranged to oscillate at frequencies less than 100 Hz.

5. An electrical generator as defined in claim 1, which incorporates a DC to DC voltage converter and a voltage detector.

6. An electric generator as defined in claim 3 which includes an electronic switching device that senses if the harvested energy level id adequate for the demands of the application for continuous operation, and switches from continuous to a duty cycle mode if the level is insufficient for continuous mode.

7. An electric generator as defined in claim 3 in which a plurality of coils are mounted in a carrier suspended by a torsion wire such that the carrier and coils are able to move between a series of magnets closely spaced adjacent either face of the carrier and a counter weight is fitted to the carrier at a position out side the periphery of the magnets.

8. A device which incorporates a transponder and optionally sensors or identification data which is powered by an electrical generator as claimed in claim 1.
